(19) United States
(12) Patent Application Publication
(10) Pub. No.: US 2012/0147004 A1
(43) Pub. Date: Jun. 14, 2012

(54) APPARATUS AND METHOD FOR GENERATING DIGITAL ACTOR BASED ON MULTIPLE IMAGES

(75) Inventors: Yoon-Seok CHOI, Daejeon (KR); Ji-Hyung LEE, Daejeon (KR); Bon-Ki KOO, Daejeon (KR)

(73) Assignee: Electronics and Telecommunications Research Institute, Daejeon-city (KR)

(21) Appl. No.: 13/324,581

(22) Filed: Dec. 13, 2011

(30) Foreign Application Priority Data
Dec. 13, 2010 (KR) 10-2010-0127148

(51) Int. Cl. G06T 13/00; G06T 17/00; G09G 5/00

(52) U.S. Cl. 345/420; 345/586

(57) ABSTRACT

Disclosed herein is an apparatus for generating a digital actor based on multiple images. The apparatus includes a reconstruction appearance generation unit, a texture generation unit, and an animation assignment unit. The reconstruction appearance generation unit generates a reconstruction model in which the appearance of a target object is reconstructed in such a way as to extract 3-Dimensional (3D) geometrical information of the target object from images captured using multiple cameras which are provided in directions which are different from each other. The texture generation unit generates a texture image for the reconstruction model based on texture coordinates information calculated based on the reconstruction model. The animation assignment unit allocates an animation to each joint of the reconstruction model, which has been completed by applying the texture image to the reconstruction model, in such a way as to add motion data to the joint.

### CROSS REFERENCE TO RELATED APPLICATION

This application claims the benefit of Korean Patent Application No.10-2010-0127148, filed on Dec. 13, 2010, which is hereby incorporated by reference in its entirety into this application.

### BACKGROUND OF THE INVENTION

1. Technical Field

The present invention relates generally to an apparatus and method for generating a digital actor based on multiple images, and, more particularly, to an apparatus and method for generating a digital actor based on multiple images, which automatically generates the appearance mesh and texture information of a 3-Dimensional (3D) model which can be used in 3D computer graphics based on 3D geometrical information extracted from multiple images, and which adds motion data to each of the generated appearance mesh and the texture information, thereby generating a complete digital actor.

2. Description of the Related Art

Recently, digital actors have become core technology for generating special effects in games, movies, and broadcasting. Digital actors resembling heroes have been used in main scenes, such as a challenge scene and a flight scene, in various types of movies. In some movies, all of the scenes have been made in computer graphics using digital actors.

As described above, although the importance and utilization of digital actors have increased in games, movies, and broadcasting, a plurality of operations are required to manufacture such a digital actor. Information required to reproduce the actor is generated by acquiring geometrical information about the 3D appearance of a target actor using laser, and extracting color information using pictures of the actor.

The operations of manufacturing a digital actor are divided into a motion capture operation and a digital scanning operation. The motion capture operation is performed in such a way that digital marks are attached to the body of an actor, the actor performs an actual action, and then the motion is extracted and applied to a digital actor, thereby performing the same action. The digital scanning operation is used to make the appearance of the digital actor. In games, such as basketball, baseball, and football, the appearance of a player who is famous in real world is scanned such that the feeling of playing a game with the actual player is maintained in the game.

However, it takes a long time and is hard to generate the all computer graphics characters of digital actors appearing in a movie or a game. In particular, it may be wasteful to manufacture actors corresponding to extra in high quality. Although extras, such as animals or monsters which are not human, may be reused by transforming models, humans whose faces are exposed cannot be reused.

Therefore, it is necessary to provide a method of easily manufacturing a digital actor.

### SUMMARY OF THE INVENTION

Accordingly, the present invention has been made keeping in mind the above problems occurring in the prior art, and an object of the present invention is to provide an apparatus and method for generating a digital actor based on multiple images, which generates the appearance information of a target object and generates texture used to realistically describe the appearance based on multiple images, and supports an animation used to control motions, thereby easily generating a digital actor, used for special effects in movies and dramas, and personal characters used in games.

In order to accomplish the above object, the present invention provides an apparatus for generating a digital actor based on multiple images, including: a reconstruction appearance generation unit for generating a reconstruction model in which the appearance of a target object is reconstructed in such a way as to extract the 3-Dimensional (3D) geometrical information of the target object from images captured using multiple cameras which are provided in directions which are different from each other; a texture generation unit for generating a texture image for the reconstruction model based on texture coordinates information calculated based on the reconstruction model; and an animation assignment unit for allocating an animation to each joint of the reconstruction model, which has been completed by applying the texture image to the reconstruction model, in such a way as to add motion data to the joint.

The reconstruction appearance generation unit may generate the reconstruction model based on the images synchronized with each other.

The reconstruction appearance generation unit may include: a calibration unit for calculating camera parameter values based on the relative locations of the multiple cameras using calibration patterns for the respective images; and an interest area extraction unit for extracting the target object from each of the images and generating the mask information of the target object.

The reconstruction appearance generation unit may calculate the 3D geometrical information based on the camera parameter values and the mask information.

The reconstruction appearance generation unit may further include a reconstruction model correction unit for correcting the appearance of the reconstruction model.

The texture generation unit may include a texture coordinates generation unit for dividing the reconstruction model into a plurality of sub meshes, calculating texture coordinates values in units of a sub mesh, and integrating the texture coordinates values in units of the sub mesh, thereby generating the texture coordinates value of the reconstruction model.

The texture generation unit may allocate the index information of each polygon, which corresponds to the texture coordinates value, to the texture image, projects the polygon to the relevant image, and then allocates the image of the polygon, which was projected to the relevant image, to the texture image.

The texture generation unit may further include a texture image correction unit for correcting the boundary of the texture image in such a way as to extend the value of a portion, to which the image of the polygon is allocated, to a portion, in which the image of the polygon is not allocated, both the portions corresponding to the boundary of the texture image.

The animation assignment unit may include a skeleton retargeting unit for calling skeleton structure information which has been previously defined, and retargeting the skeleton structure information based on the reconstruction model; and a bone-vertex assignment unit for assigning each vertex of the reconstruction model to adjacent bones based on the retargeted skeleton structure information.

The animation assignment unit may call a motion file which has been previously captured, and obtains the motion data of the reconstruction model based on the motion file.

The apparatus may further include a model compatibility support unit for preparing the reconstruction model, the texture images, and the animation using a standard document format, and providing a function of exporting the reconstruction model based on the standard document format in another application program or a virtual environment.

In order to accomplish the above object, the present invention provides a method of generating a digital actor based on multiple images, the method including: generating a reconstruction model in which the appearance of a target object is reconstructed in such a way as to extract 3D geometrical information of the target object from images captured using multiple cameras which are provided in directions which are different from each other; generating a texture image for the reconstruction model based on texture coordinates information calculated based on the reconstruction model; and allocating an animation to each joint of the reconstruction model, which has been completed by applying the texture image to the reconstruction model, in such a way as to add motion data to the joint.

The generating the reconstruction model may include: calculating camera parameter values based on the relative locations of the multiple cameras using calibration patterns for the respective images; and extracting the target object from each of the images and generating mask information of the target object.

The generating the reconstruction model may include calculating the 3D geometrical information based on the camera parameter values and the mask information.

The generating the reconstruction model may further include correcting the appearance of the reconstruction model.

The generating the texture image may include: dividing the reconstruction model into a plurality of sub meshes; calculating texture coordinates values in units of the sub mesh; and integrating the texture coordinates values in units of the sub mesh.

The generating the texture image may include: allocating index information of each polygon, which corresponds to the texture coordinates value, to the texture image; and projecting the polygon to the relevant image, and then allocating the image of the polygon, which was projected to the relevant image, to the texture image.

The generating the texture image may include: allocating polygons to an image in which a texture will be calculated; determining whether the polygons overlap with each other in the image on which the polygons are allocated; and when the polygons overlap with each other, allocating a polygon, which is located on a backside, to another adjacent image.

The generating the texture image may further include correcting the boundary of the texture image in such a way as to extend the value of a portion, to which the image of the polygon is allocated, to a portion, in which the image of the polygon is not allocated, both the portions corresponding to the boundary of the texture image.

The method may further include preparing the reconstruction model, the texture images, and the animation using a standard document format, and providing a function of exporting the reconstruction model based on the standard document format in another application program or a virtual environment.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an example of multiple camera arrangement structure according to the present invention;

FIG. 2 is a block diagram illustrating the configuration of an apparatus for generating a digital actor based on multiple images according to the present invention;

FIG. 3 is a block diagram illustrating the configuration of a reconstruction appearance generation unit according to the present invention;

FIGS. 4 and 5 are views illustrating examples of the operation of the reconstruction appearance generation unit according to the present invention;

FIG. 6 is a block diagram illustrating the configuration of a texture generation unit according to the present invention;

FIGS. 7 to 10 are views illustrating examples of the operation of the texture generation unit according to the present invention;

FIG. 11 is a block diagram illustrating the configuration of an animation assignment unit according to the present invention;

FIGS. 12 and 13 are views illustrating the examples of the operation of the animation assignment unit according to the present invention; and

FIGS. 14 and 15 are flowcharts illustrating the operational flow of a method of generating a digital actor based on multiple cameras according to the present invention.

### DESCRIPTION OF THE PREFERRED EMBODIMENTS

Embodiments of the present invention will be described in detail with reference to the accompanying drawings below.

When detailed descriptions of well-known functions or configurations may make unnecessarily obscure the gist of the present invention, the detailed descriptions will be omitted. Further, terms which will be described later have been defined in consideration of the functions thereof in the present invention, and they may differ according to the intent or customs of a user or a manager. Therefore, the terms should be defined based on the content of the entire specification.

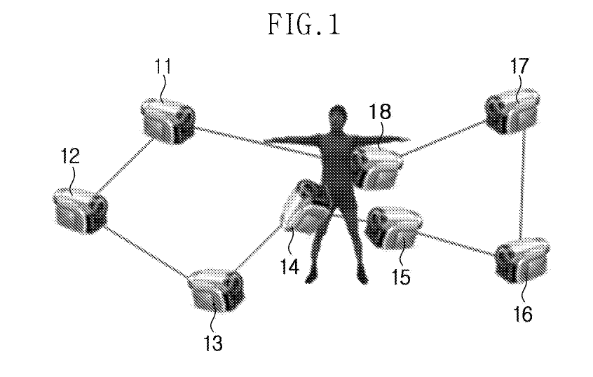

FIG. 1 is a block diagram illustrating the concept of a system according to the present invention.

As shown in FIG. 1, in an apparatus for generating a digital actor based on multiple images according to the present invention (hereinafter referred to as ‘digital actor generation apparatus’), in order to generate a digital actor, multiple cameras 11 to 18 are allocated at respective angles which are different from each other while centering on a target object which is desired to be made into the digital actor, and then the pictures of the target object are taken.

Here, the cameras 11 to 18 are synchronized with each other and are configured to take a picture of the target object at the same time, so that the digital actor generation apparatus can generate a digital actor using synchronized images.

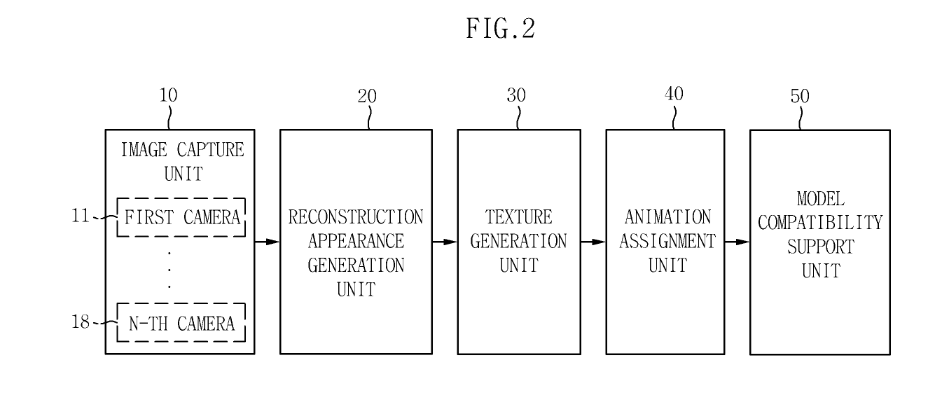

FIG. 2 is a block diagram illustrating the configuration of the digital actor generation apparatus based on multiple images according to the present invention.

As shown in FIG. 2, the digital actor generation apparatus based on multiple cameras according to the present invention includes an image capture unit 10, a reconstruction appearance generation unit 20, a texture generation unit 30, an animation assignment unit 40, and a model compatibility support unit 50.

The image capture unit 10 includes the multiple cameras 11 to 18 shown in FIG. 1. The image capture unit 10 outputs images, which are captured in real time using the multiple cameras 11 to 18, to the reconstruction appearance generation unit 20.

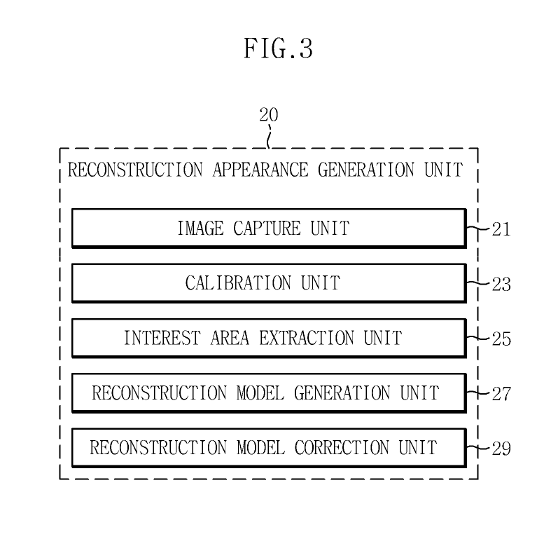

The reconstruction appearance generation unit 20 obtains a plurality of synchronized images from the multiple cameras 11 to 18, and then reconstructs the appearance of the target object based on the images. The configuration of the reconstruction appearance generation unit 20 will be described in detail with reference to FIG. 3.

The texture generation unit 30 generates textures in order to providing the realistic rendering of the reconstruction model which was reconstructed using the reconstruction appearance generation unit 20. The configuration of the texture generation unit 30 will be described in detail with reference to FIG. 6.

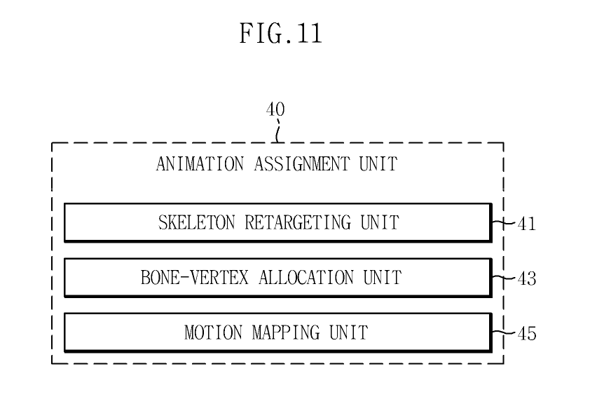

The animation assignment unit 40 controls the operation of the completed reconstruction model. The configuration of the animation assignment unit 40 will be described in detail with reference to FIG. 11.

The model compatibility support unit 50 maintains compatibility which can be used in another virtual space. That is, the model compatibility support unit 50 provides a model export function based on a standard document format such that the reconstructed 3D model, the texture and animation thereof may be used by another application program or in another virtual environment.

FIG. 3 is a block diagram illustrating the configuration of the reconstruction appearance generation unit according to the present invention.

Referring to FIG. 3, the reconstruction appearance generation unit 20 includes an image capture unit 21, a calibration unit 23, an interest area extraction unit 25, a reconstruction model generation unit 27, and a reconstruction model correction unit 29.

The image capture unit 21 captures images using the multiple cameras 11 to 18.

The calibration unit 23 performs calibration on the images captured using the image capture unit 21. Here, the calibration unit 23 searches for the actual parameters of the respective cameras using a calibration pattern based on the relative positions of the multiple cameras 11 to 18, and then calculates the resulting values thereof

The interest area extraction unit 25 extracts a desired target object based on the received images and then generates the mask information of the target object. Here, the interest area extraction unit 25 extracts the target object using a chroma-key or codebook-based static background extraction method or using a stereo-based background extraction method in a dynamic environment.

The reconstruction model generation unit 27 calculates the 3D geometrical information of the target object based on the plurality of images, the information about the camera parameters calculated using the calibration unit 23, and the mask information of the target object. Here, the reconstruction model generation unit 27 generates a reconstruction model based on the 3D geometrical information of the target object using a volume-based mesh technique. Here, the reconstruction model corresponds to a 3D mesh model.

The reconstruction model correction unit 29 corrects the appearance of the reconstruction model generated using the reconstruction model generation unit 27. Here, the reconstruction model correction unit 29 performs an operation of softening the appearance of the reconstruction model in order to solve a quality deterioration problem attributable to discontinuous surfaces generated on the appearance of the reconstruction model generated using the volume-based technique.

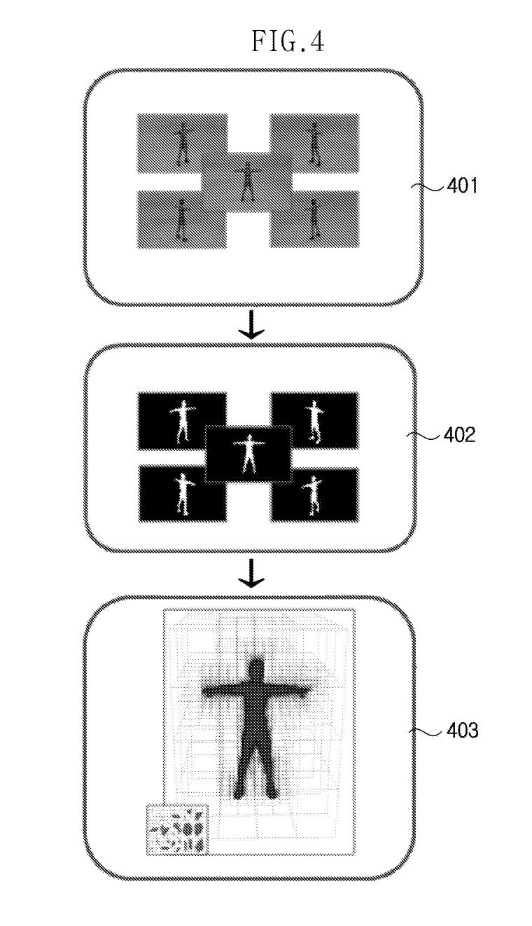

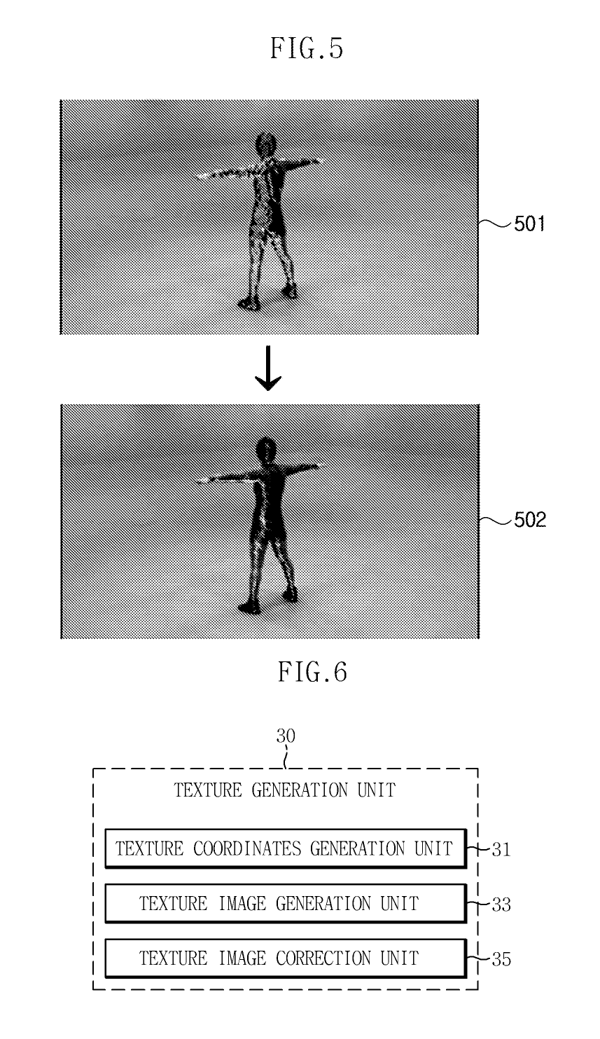

FIGS. 4 and 5 are views illustrating examples of the operation of the reconstruction appearance generation unit according to the present invention.

First, FIG. 4 is a view illustrating the operations of the calibration unit, the interest area extraction unit, and the reconstruction model generation unit. In FIG. 4, the calibration unit performs calibration on the images 401 captured using the multiple cameras 11 to 18. The interest area extraction unit 25 extracts interest areas 402, that is, the mask information of a target object, from the images 401, on which calibration has been performed.

Thereafter, the reconstruction model generation unit 27 generates a reconstruction model 403 in such a way as to calculate the 3D geometrical information of the target object based on the mask information of the target object extracted from 402.

FIG. 5 is a view illustrating the operation of the reconstruction model correction unit. In FIG. 5, an image of the plurality of images captured from various angles will be described as an embodiment.

The reconstruction model correction unit 29 softens the overall appearance in such a way as to reduce the stair-step effect generated on the appearance of the reconstruction model attributable to the volume-based technique.

Meanwhile, the reconstruction model generation unit 27 generates the reconstruction model using the volume-based mesh technique. Here, a marching cube technique, that is, the volume-based mesh technique, constructs appearance mesh using specifically patterned polygons, so that the stair-step effect is generated on the appearance of the reconstruction model. Here, the polygons formed on the reconstruction model have limited directionality. Therefore, when polygon images are allocated, polygons may not be allocated on images, captured from specific directions, at all.

Referring to FIG. 5, the reconstruction model correction unit 29 overlaps the reconstruction models on the plurality of images 501, and draws polygons allocated to the respective images. Here, the reconstruction model correction unit 29 performs a correction operation on the images 501 and then generates a reconstruction model 502.

FIG. 6 is a block diagram illustrating the configuration of the texture generation unit according to the present invention.

Referring to FIG. 6, the texture generation unit 30 includes a texture coordinates generation unit 31, a texture image generation unit 33, and a texture image correction unit 35.

The texture coordinates generation unit 31 calculates the texture information of the reconstruction model and then generates a texture coordinates value.

Here, the texture coordinates generation unit 31 divides the reconstruction model into sub meshes in which textures can be easily generated, and then generates texture coordinates values in units of a sub mesh using a projective mapping technique. Here, the texture coordinates generation unit 31 integrates the texture coordinates values in units of the sub mesh into a single texture, thereby generating a texture coordinates value for the reconstruction model.

The texture image generation unit 33 generates a texture image based on the reconstruction model, images captured using the multiple cameras 11 to 18, the mask information of the target object, and texture coordinates information.

Here, the texture image generation unit 33 tracks corresponding polygons in texture space and rendering image space, and then generates an optimal texture image using the transformation of the tracked polygons.

That is, the texture image generation unit 33 allocates an optimal image, used to extract a texture, to each of the polygons based on the polygons of the reconstruction model, and then reallocates an image captured using an adjacent camera to an overlapping polygon.

The determination about whether polygons overlap and the reallocation are performed using the depth values (Z depth) of the polygons based on the camera which captured the allocated image. An adjacent image is allocated to the concealed polygon of the overlapping polygons. Here, the texture image generation unit 33 generates a texture image based on the image allocated to each polygon.

The texture image correction unit 35 corrects the texture image generated using the texture image generation unit 33 for the purpose of increasing quality.

The boundary of sub textures is divided due to the generation of the textures in units of a sub texture and separated spaces are generated when texture mapping is applied. Therefore, the texture image correction unit 35 corrects the separated spaces.

Here, the texture image correction unit 35 generates a mask using a polygon-image allocation table, and then extracts boundary portions of the mask. Further, the texture image correction unit 35 extends the value of a portion, having a polygon-image allocation value and corresponding to the extracted boundary portion of the mask, thereby generating a supplemented texture.

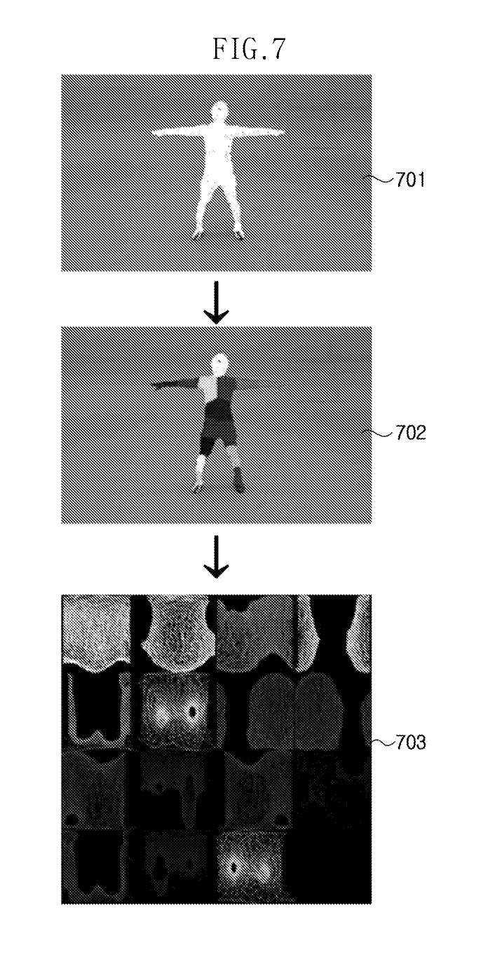

FIGS. 7 to 10 are views illustrating examples of the operation of the texture generation unit according to the present invention.

First, FIG. 7 illustrates an embodiment showing the operation of the texture coordinates generation unit.

In FIG. 7, reference numeral 701 indicates a reconstruction model, and reference numeral 702 indicates the reconstruction model 701 divided into a plurality of sub meshes. Further, reference numeral 703 indicates a texture coordinates value in which sub texture coordinates values, generated for the respective sub meshes, are integrated into a single coordinate value.

As shown in FIG. 7, the texture coordinates generation unit 31 divides the reconstruction model 701 into a plurality of sub meshes 702 in order to generate the texture coordinates value of the reconstruction model generated using the reconstruction appearance generation unit 20. The sub meshes are displayed using different brightness in order to distinguish the sub meshes 702 from each other. Here, division is performed on the texture coordinates value using information about vertices of 3D meshes included in the reconstruction model such that the resulting values correspond to K sub meshes.

The texture coordinates generation unit 31 generates sub texture coordinates values corresponding to the respective sub meshes in such a way as to perform a projective mapping technique on the sub meshes.

Finally, the texture coordinates generation unit 31 integrates the sub texture coordinates values and makes a single coordinate value 703, thereby completing the texture coordinates value for the reconstruction model 701.

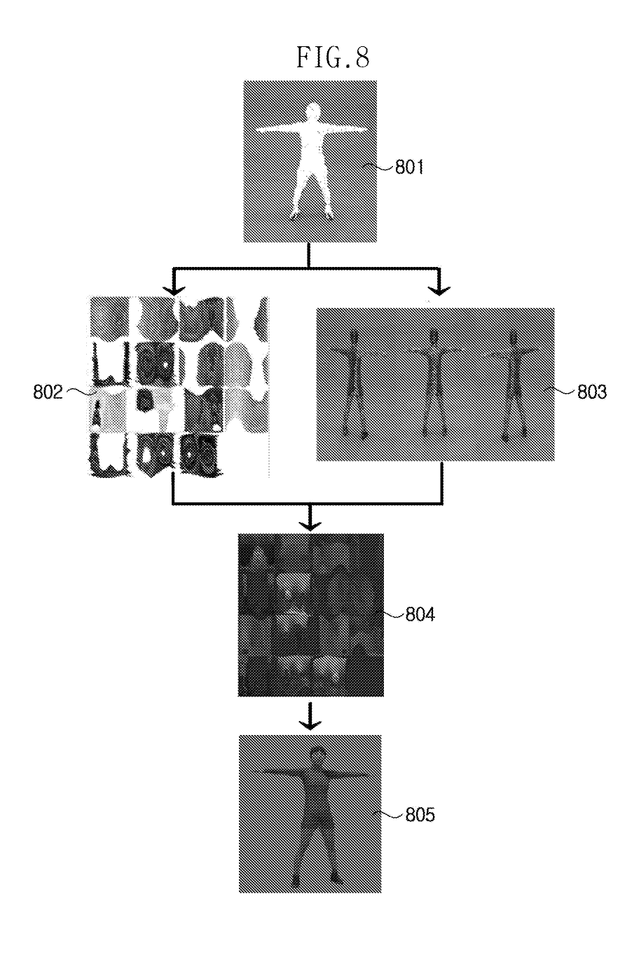

FIG. 8 illustrates an embodiment showing the operation of the texture image generation unit.

Referring to FIG. 8, the texture image generation unit 33 defines a target texture image with respect to a reconstruction model 801, and allocates the index information of polygons corresponding to the completed texture coordinates value of FIG. 7, thereby generating a primary texture image 802.

Here, the texture image generation unit 33 colors the polygons using colors corresponding to the polygon index values based on texture coordinates values allocated to the respective polygons. An area, which is not colored in the primary texture image 802, indicates an area to which a polygon is not allocated.

Therefore, the texture image generation unit 33 does not calculate a value corresponding to an empty space, to which the index information is not allocated, in the texture space, and reads the value of a space, to which the index information is allocated, from an image allocated using an inverse texture mapping technique based on the corresponding index information.

Thereafter, the texture image generation unit 33 allocates an image to each polygon.

Here, the texture image generation unit 33 compares the direction vector of a polygon with each of the directions of the respective cameras 11 to 18, and allocates an image, captured using the camera in which the direction is identical with the corresponding direction vector, to the corresponding polygon.

Here, occlusion may occur between polygons allocated to a specific image. In this case, the texture image generation unit 33 allocates an adjacent image to the polygon, which is located in an area which is far from the corresponding camera, from among the polygons, which interfere with each other, based on the interference between the polygons included in the specific image.

Meanwhile, an image 803 indicates that the reconstruction model is combined with the images and then polygons, which are allocated to each of the images, are displayed on each of the images.

Therefore, the texture image generation unit 33 generates a secondary texture image 804 based on the primary texture images 802 and the image 803. In FIG. 8, an image 805 indicates a reconstruction model which has been completed based on the secondary texture image 804.

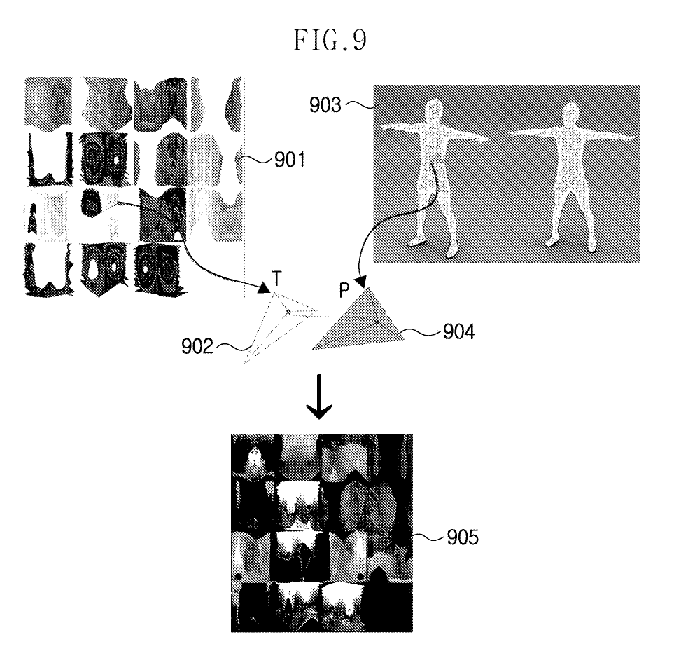

FIG. 9 illustrates an embodiment showing the operation of the texture image generation unit as in FIG. 8, that is, an operation of determining the color of the texture image.

Referring to FIG. 9, the color value T(u, v) of each coordinate value of a texture is used to determine a target polygon F based on index information which has been previously stored. Here, the texture image generation unit 33 obtains a polygon T, projected on a texture image, with respect to the target polygon F.

Further, the texture image generation unit 33 determines an image I 903, from which the texture will is extracted, in such a way as to read a polygon-image allocation table value corresponding to the polygon F, and then determines the parameter of the camera which captured the corresponding image 903. Here, the texture image generation unit 33 projects the polygon F on the image I based on the parameter of the corresponding camera, thereby obtaining a projection polygon P 904.

Therefore, the texture image generation unit 33 determines the color of the corresponding texture image using a warping function with respect to the polygon projected on the texture image and the polygon projected on the image. Here, an algorithm used to determine a color corresponding to each coordinate value (u, v) is as follows:

For u=0 to Texture_Width
{

For v=0 to Texture_Height
{

Polygon F = Polygon_Index(u, v);
Image I = Polygon_Image_Table F;
Polygon_On_Texture T = Project(F, Texture);
Polygon_On_Image P = Project(F, I);
Texel_Color(u, v) = Warp(T, P, u, v);

}

}

Such an operation can be independently performed using each pixel in units of the texture image coordinate value (u, v), so that parallel calculation can be performed. The operation is performed regardless of the increase in the number of polygons of the reconstruction model, and the time required to perform the operation is determined only based on the size of a texture to be reconstructed. Further, the parallel process is performed in units of each pixel of the texture image, so that an appropriate response time may be guaranteed even when the size of the texture image increases.

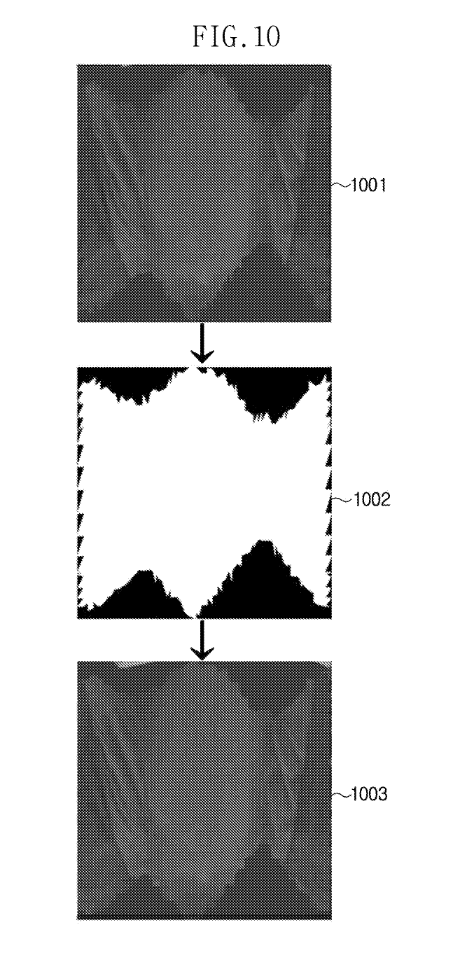

FIG. 10 is a view illustrating an embodiment showing the operation of the texture image correction unit according to the present invention.

Referring to FIG. 10, since the texture image correction unit 35 generates a texture image in units of a sub texture in the texture image generation process, the boundary of sub textures is divided, and separated spaces appear on the texture of the reconstruction model when matching is applied.

Therefore, the texture image correction unit 35 performs correction based on the outline of the texture.

That is, the texture image correction unit 35 generates a texture mask for a primarily generated texture using the polygon-image allocation table. Here, the texture image correction unit 35 extracts the boundary of the texture mask, and extends the value of a portion, having a polygon-image allocation value and corresponding to the extracted boundary, thereby correcting the outline of the texture.

FIG. 11 is a block diagram illustrating the configuration of the animation assignment unit according to the present invention.

Referring to FIG. 11, the animation assignment unit 40 according to the present invention provides a function capable of controlling the operation of the reconstruction model based on a given skeleton structure. Here, the animation assignment unit 40 includes a skeleton retargeting unit 41, a bone-vertex assignment unit 43, and a motion mapping unit 45.

First, the skeleton retargeting unit 41 calls skeleton structure information which has been previously designed, and retargets a skeleton based on the reconstruction model according to the input of a user. Here, the skeleton retargeting unit 41 transforms the upper skeleton first and then transforms the lower skeleton.

The bone-vertex assignment unit 43 performs a skinning operation of assigning each vertex of the reconstruction model to adjacent bones based on the retargeted skeleton.

The motion mapping unit 45 transplants motion data which is desired to be applied to the reconstruction model. Here, the motion mapping unit 45 reads a motion file which has been previously written, such as HTR, and applies the content of the motion file to each of the skeletons of the reconstruction model.

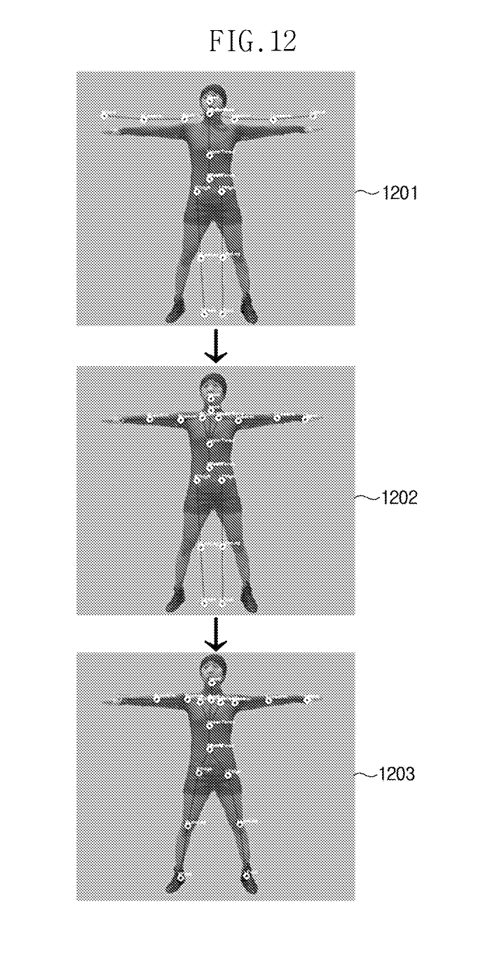

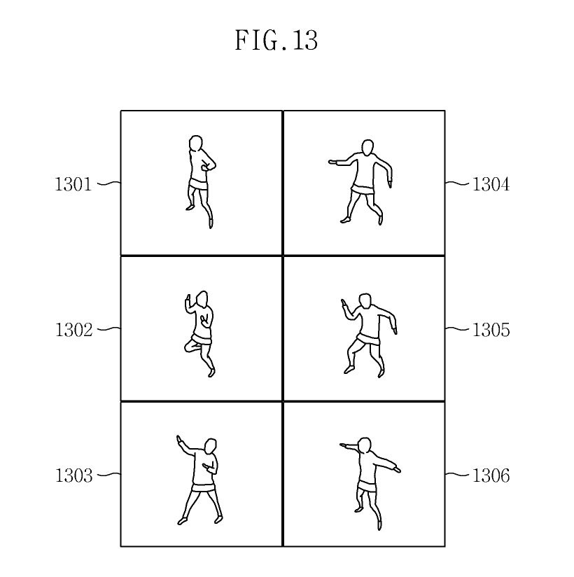

FIGS. 12 and 13 are views illustrating the examples of the operation of the animation assignment unit according to the present invention.

First, FIG. 12 illustrates an embodiment showing the operation of the skeleton retargeting unit according to the present invention. As shown in FIG. 12, the skeleton retargeting unit 41 first calls skeleton information 1201.

Here, the skeleton retargeting unit 41 transforms the upper skeleton information 1202 based on the called skeleton information 1201. Further, the skeleton retargeting unit 41 transforms the lower skeleton information 1203.

FIG. 13 illustrates an embodiment showing the operation of the motion mapping unit according to the present invention. FIG. 13 illustrates respective pieces of motion data 1301 to 1306, and the motion mapping unit 45 reads a motion file, and checks the motion data of the corresponding motion file.

Thereafter, the motion mapping unit 45 applies the pieces of motion data 1301 to 1306 to the respective skeletons of the reconstruction model. In this case, the reconstruction model operates based on the respective pieces of motion data 1301 to 1306.

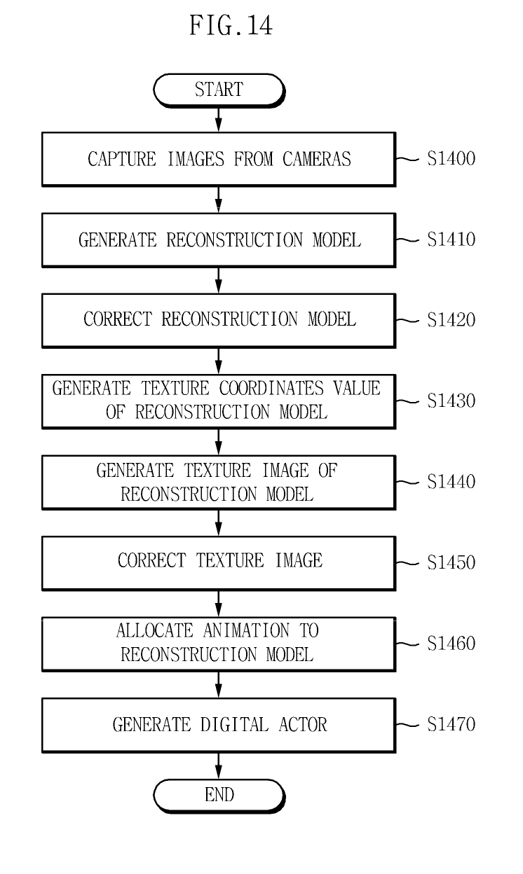

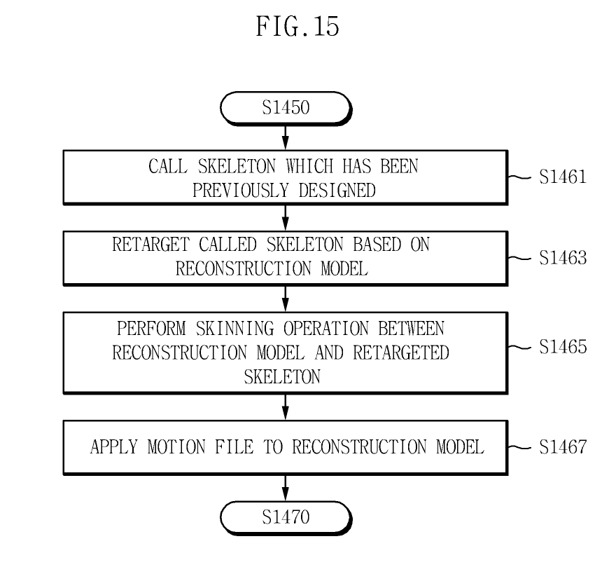

FIGS. 14 and 15 are flowcharts illustrating the operational flow of a method of generating a digital actor based on multiple cameras according to the present invention.

As shown in FIG. 14, when the digital actor generation apparatus according to the present invention captures images from the multiple cameras 11 to 18 which are provided in directions different from each other at step S1400, the digital actor generation apparatus extracts geometrical information from the captured images and generates a reconstruction model at step S1410. Further, the digital actor generation apparatus performs correction on the appearance of the reconstruction model, generated at step S1410, at step S1420.

Thereafter, the digital actor generation apparatus generates a texture coordinates value in such a way as to calculate the texture information of the completed reconstruction model at step S1430, and then generates a texture image based on the texture coordinates value at step S1440. At step S1440, the digital actor generation apparatus generates the texture image based on the reconstruction model, images captured using the multiple cameras 11 to 18, and the mask information of a target object, as well as the texture coordinates value.

Here, the texture image, generated at step S1440, is generated in units of a sub texture. Therefore, the digital actor generation apparatus extends a value allocated to the boundary of the texture image generated in units of a sub texture, thereby correcting the outline of the texture image at step S1450.

The digital actor generation apparatus applies the texture image, completed at step S1450, to the reconstruction model, thereby completing the reconstruction model for the target object.

Meanwhile, the digital actor generation apparatus allocates an animation in order to control the motion of the completed reconstruction model at step S1460.

A process of allocating the animation to the reconstruction model will be described with reference to FIG. 15.

As shown in FIG. 15, the digital actor generation apparatus calls skeleton information, which has been previously designed, at step S1461, and then retargets the called skeleton information based on the reconstruction model at step S1463.

Here, the digital actor generation apparatus performs a skinning operation of assigning each vertex of the reconstruction model to the adjacent bones based on the retargeted skeleton at step S1465.

Thereafter, the digital actor generation apparatus reads a motion file which has been previously written, and applies motion data corresponding to the motion file to each skeleton of the corresponding reconstruction model at step S1467.

Therefore, the digital actor generation apparatus completes the generation of a digital actor at step S1470.

According to the present invention, there is an advantage of adding a function of enabling a user to conveniently and rapidly reconstruct the appearance of a 3D model for a target object, such as a digital actor or an avatar which is necessary for a virtual space to be implemented in movies, broadcasting and games, compared to an existing laser scanning or stereo method, and to control the motion of the 3D model.

Further, the present invention allows a digital actor or an avatar to be stored in a standard format which is suitable for the purpose of a virtual space, and to be shared in spaces which are different from each other, so that the same avatar may be maintained in virtual spaces which are different from each other. Therefore, there is an advantage of increasing the use of a digital actor.

Although the apparatus and method for generating a digital actor based on multiple cameras according to the present invention has been described with reference to the exemplified drawings, the present invention is not limited to the disclosed embodiments and drawings and those skilled in the art will appreciate that various modifications, additions and substitutions are possible, without departing from the scope and spirit of the invention as disclosed in the accompanying claims.

What is claimed is:

1. An apparatus for generating a digital actor based on multiple images, comprising:
a reconstruction appearance generation unit for generating a reconstruction model in which an appearance of a target object is reconstructed in such a way as to extract 3-Dimensional (3D) geometrical information of the target object from images captured using multiple cameras which are provided in directions which are different from each other;
a texture generation unit for generating a texture image for the reconstruction model based on texture coordinates information calculated based on the reconstruction model; and
an animation assignment unit for allocating an animation to each joint of the reconstruction model, which has been completed by applying the texture image to the reconstruction model, in such a way as to add motion data to the joint.

2. The apparatus as set forth in claim 1, wherein the reconstruction appearance generation unit generates the reconstruction model based on the synchronized images.

3. The apparatus as set forth in claim 1, wherein the reconstruction appearance generation unit comprises:
a calibration unit for calculating camera parameter values based on the relative locations of the multiple cameras using calibration patterns for the respective images; and
an interest area extraction unit for extracting the target object from each of the images and generating mask information of the target object.

4. The apparatus as set forth in claim 3, wherein the reconstruction appearance generation unit calculates the 3D geometrical information based on the camera parameter values and the mask information.

5. The apparatus as set forth in claim 1, wherein the reconstruction appearance generation unit further comprises a reconstruction model correction unit for correcting the appearance of the reconstruction model.

6. The apparatus as set forth in claim 1, wherein the texture generation unit comprises a texture coordinates generation unit for dividing the reconstruction model into a plurality of sub meshes, calculating texture coordinates values in units of a sub mesh, and integrating the texture coordinates values in units of the sub mesh, thereby generating a texture coordinates value of the reconstruction model.

7. The apparatus as set forth in claim 6, wherein the texture generation unit allocates index information of each polygon, which corresponds to the texture coordinates value, to the texture image, projects the polygon to the relevant image, and then allocates an image of the polygon, which was projected to the relevant image, to the texture image.

8. The apparatus as set forth in claim 7, wherein the texture generation unit further comprises a texture image correction unit for correcting boundary of the texture image in such a way as to extend a value of a portion, to which the image of the polygon is allocated, to a portion, in which the image of the polygon is not allocated, both the portions corresponding to the boundary of the texture image.

9. The apparatus as set forth in claim 1, wherein the animation assignment unit comprises:
a skeleton retargeting unit for calling skeleton structure information which has been previously defined, and retargeting the skeleton structure information based on the reconstruction model; and
a bone-vertex assignment unit for assigning each vertex of the reconstruction model to adjacent bones based on the retargeted skeleton structure information.

10. The apparatus as set forth in claim 1, wherein the animation assignment unit calls a motion file which has been previously captured, and obtains motion data of the reconstruction model based on the motion file.

11. The apparatus as set forth in claim 1, further comprising a model compatibility support unit for preparing the reconstruction model, the texture images, and the animation using a standard document format, and providing a function of exporting the reconstruction model based on the standard document format in another application program or a virtual environment.

12. A method of generating a digital actor based on multiple images, the method comprising:
generating a reconstruction model in which an appearance of a target object is reconstructed in such a way as to extract 3D geometrical information of the target object from images captured using multiple cameras which are provided in directions which are different from each other;
generating a texture image for the reconstruction model based on texture coordinates information calculated based on the reconstruction model; and
allocating an animation to each joint of the reconstruction model, which has been completed by applying the texture image to the reconstruction model, in such a way as to add motion data to the joint.

13. The method as set forth in claim 12, wherein the generating the reconstruction model comprises:
calculating camera parameter values based on the relative locations of the multiple cameras using calibration patterns for the respective images; and
extracting the target object from each of the images and generating mask information of the target object.

14. The method as set forth in claim 13, wherein the generating the reconstruction model comprises calculating the 3D geometrical information based on the camera parameter values and the mask information.

15. The method as set forth in claim 12, wherein the generating the reconstruction model further comprises correcting the appearance of the reconstruction model.

16. The method as set forth in claim 12, wherein the generating the texture image comprises:
dividing the reconstruction model into a plurality of sub meshes;
calculating texture coordinates values in units of the sub mesh; and
integrating the texture coordinates values in units of the sub mesh.

17. The method as set forth in claim 16, wherein the generating the texture image comprises:
allocating index information of each polygon, which corresponds to the texture coordinates value, to the texture image; and
projecting the polygon to the relevant image, and then allocating an image of the polygon, which was projected to the relevant image, to the texture image.

18. The method as set forth in claim 17, wherein the generating the texture image comprises:
allocating polygons to an image in which a texture will be calculated;
determining whether the polygons overlap with each other in the image on which the polygons are allocated; and
when the polygons overlap with each other, allocating a polygon, which is located on a backside, to another adjacent image.

19. The method as set forth in claim 17, wherein the generating the texture image further comprises correcting boundary of the texture image in such a way as to extend a value of a portion, to which the image of the polygon is allocated, to a portion, in which the image of the polygon is not allocated, both the portions corresponding to the boundary of the texture image.

20. The method as set forth in claim 12, further comprises preparing the reconstruction model, the texture images, and the animation using a standard document format, and providing a function of exporting the reconstruction model based on the standard document format in another application program or a virtual environment.
